(19) United States
(12) Patent Application Publication
(10) Pub. No.: US 2026/0148318 A1
(43) Pub. Date: May 28, 2026

(54) ELECTRONIC DEVICE FOR PROVIDING INTERACTIVE CHATBOT SEARCH SERVICES BASED ON PERSONAL CHARACTERISTICS AND EXPERIENCES, AND OPERATING METHOD THEREOF

(71) Applicant: Inha Technical College Institute for Research & Industry Cooperation, Incheon (KR)

(72) Inventors: YONGJIN JOO, Incheon (KR); SEONGGYU JEON, Siheung-si (KR); YUJIN LEE, Incheon (KR)

(21) Appl. No.: 19/363,010

(22) Filed: Oct. 20, 2025

(30) Foreign Application Priority Data
Nov. 22, 2024 (KR) 10-2024-0168593

(51) Int. Cl. G06Q 50/12; G06F 18/241; G06Q 30/0601

(52) U.S. Cl. CPC G06Q 50/12; G06F 18/241; G06Q 30/0631

(57) ABSTRACT

An electronic device for providing interactive chatbot search services based on personal characteristics and experiences, and an operating method thereof are disclosed. The method of operating the electronic device may include analyzing user intent by tokenizing a text-format query received from a user into morpheme units, recommending at least one dish corresponding to the user intent through partial string matching between the text-format query tokenized into morpheme units and a category for each cluster of a pre-constructed unstructured database, and providing restaurant information related to a dish selected by the user from the at least one recommended dish in conjunction with a map service, based on location information received from the user.

### CROSS-REFERENCE TO RELATED APPLICATION

This application claims the benefit of Korean Patent Application No. 10-2024-0168593, filed on Nov. 22, 2024, in the Korean Intellectual Property Office, the entire disclosure of which is incorporated herein by reference for all purposes.

### BACKGROUND

### 1. Field of the Invention

One or more embodiments relate to an electronic device for providing interactive chatbot search services based on personal characteristics and experiences, and an operating method thereof.

### 2. Description of the Related Art

Generative artificial intelligence (AI) is a technology capable of generating new content by utilizing large language models (LLMs), neural networks, and machine learning. Such generative AI can be utilized in various application fields by generating new data, including images, videos, code, music, designs, translations, question answering, and text-based outputs, based on trained data patterns.

As an example, foodtech, a compound word of “food” and “technology”, is an industry field that analyzes consumer tastes and preferences and provides customized foods by utilizing AI, the internet of things (IoT), and the like. This foodtech focuses on providing customized dishes or menus based on personal characteristics and experiences of consumers, thereby providing a more sophisticated and personalized consumption experience.

The above information may be presented as the related art to help with the understanding of the disclosure. No arguments or decisions are made as to whether any of the above is applicable as a prior art related to the disclosure.

### SUMMARY

Embodiments provide a method and apparatus for providing a more sophisticated and personalized consumption experience to users by providing interactive chatbot search services based on personal characteristics and experiences.

Embodiments provide a method and apparatus that enable users to more intuitively select restaurant information by providing search results that reflect the user's location information.

However, the technical aspects are not limited to the aforementioned aspects, and other technical aspects may be present.

According to an aspect, there is provided an electronic device that includes at least one processor including processing circuitry, a memory including one or more storage media storing instructions, wherein the instructions, when executed by the at least one processor individually or collectively, may cause the electronic device to analyze user intent by tokenizing a text-format query received from a user into morpheme units, recommend at least one dish corresponding to the user intent through partial string matching between the text-format query tokenized into morpheme units and a category for each cluster of a pre-constructed unstructured database, and provide restaurant information related to a dish selected by the user from the at least one recommended dish in conjunction with a map service, based on location information received from the user.

The instructions, when executed by the at least one processor individually or collectively, may cause the electronic device to determine a type of dish to be recommended to the user, based on a number of categories of the unstructured database that match the tokenized query through the partial string matching.

The instructions, when executed by the at least one processor individually or collectively, may cause the electronic device to vectorize dish review data including a dish name and at least one piece of review information corresponding to the dish name, cluster the vectorized dish review data into at least one cluster, and pre-construct the unstructured database by assigning a category to the dish review data included in the at least one cluster based on a predetermined classification method.

The instructions, when executed by the at least one processor individually or collectively, may cause the electronic device to generate at least one cluster by clustering the vectorized dish review data based on density and distance.

The instructions, when executed by the at least one processor individually or collectively, may cause the electronic device to assign a category to the dish review data included in the at least one cluster through a first classification model trained to assign one of predefined categories for each of the at least one cluster to the dish review data included in the at least one cluster, and a second classification model trained to assign a new category using a representative review for each of the at least one cluster.

According to another aspect, there is provided a method of operating an electronic device, the method including analyzing user intent by tokenizing a text-format query received from a user into morpheme units, recommending at least one dish corresponding to the user intent through partial string matching between the text-format query tokenized into morpheme units and a category for each cluster of a pre-constructed unstructured database, and providing restaurant information related to a dish selected by the user from the at least one recommended dish in conjunction with a map service, based on location information received from the user.

The recommending of at least one dish corresponding to the user intent may include determining a type of dish to be recommended to the user, based on a number of categories of the unstructured database that match the tokenized query through the partial string matching.

The unstructured database may be generated by vectorizing dish review data including a dish name and at least one piece of review information corresponding to the dish name, clustering the vectorized dish review data into at least one cluster, and assigning a category to the dish review data included in the at least one cluster based on a predetermined classification method.

Additional aspects of embodiments will be set forth in part in the description which follows and, in part, will be apparent from the description, or may be learned by practice of the disclosure.

According to embodiments of the disclosure, by providing customized information reflecting personal characteristics and experiences for a user's query, more sophisticated search results may be provided that are differentiated from existing search services based on general names or classifications, and through this, a high-quality personalized consumption experience can be provided to users.

Furthermore, according to an embodiment of the disclosure, user convenience may be improved by providing search results reflecting the user's location information, thereby allowing the user to more intuitively select restaurant information.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an electronic device for providing interactive chatbot search services based on personal characteristics and experiences, according to an embodiment.

FIG. 2 is a flowchart illustrating a method by which an electronic device constructs an unstructured database, according to an embodiment.

FIG. 3 illustrates an example of constructing an unstructured database for providing interactive chatbot search services based on personal characteristics and experiences by assigning a category to dish review data clustered into at least one cluster, according to an embodiment.

FIG. 4 is a flowchart illustrating a method by which an electronic device provides search services using an unstructured database, according to an embodiment.

### DETAILED DESCRIPTION

The following detailed structural or functional description is provided as an example only and various alterations and modifications may be made to the examples. Accordingly, the example embodiments are not construed as limited to the disclosure and should be understood to include all changes, equivalents, and replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C”, each of which may include any one of the items listed together in the corresponding one of the phrases, or all possible combinations thereof. Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” are intended to include the plural forms as well, unless the context clearly indicates otherwise. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

The term “dish” used herein may refer to a specific food item such as pasta, steak, sushi, and the like.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings. When describing the examples with reference to the accompanying drawings, like reference numerals refer to like elements and any repeated description related thereto will be omitted.

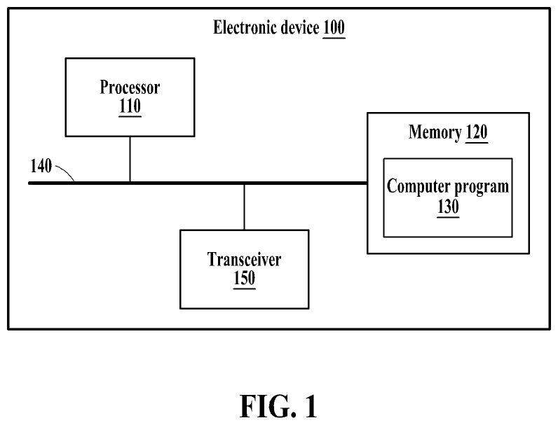

FIG. 1 illustrates an electronic device for providing interactive chatbot search services based on personal characteristics and experiences, according to an embodiment.

Referring to FIG. 1, an electronic device 100 may include one or more processors 110 and a memory 120 that loads or stores a computer program 130, which is executed by the processor 110. The processor 110 and the memory 120 may be connected to each other through a communication link (e.g., a bus 140). Optionally, the electronic device 100 may further include a transceiver 150, which can be used for data interchange, such as the transmission and/or reception of data between the electronic device 100 and other electronic devices. The components included in the electronic device 100 of FIG. 1 are merely examples, and those skilled in the art to which the disclosure pertains can understand that other general-purpose components may be further included in addition to the components shown in FIG. 1.

The processor 110 may control the overall operations of each component in the electronic device 100. The processor 110 may be implemented as circuitry such as a system on chip (SoC) or integrated circuit (IC) (e.g., processing circuitry). The processor 110 may include one or more processors. For example, the processor 110 may include a combination of one or more processors such as a central processing unit (CPU), a microprocessor unit (MPU), a micro controller unit (MCU), a graphics processing unit (GPU), a neural processing unit (NPU), a digital signal processor (DSP), an application processor (AP), a communication processor (CP), or any type of processor well known in the technical field of the disclosure. Additionally, the processor 110 may perform operations on at least one application or computer program 130 for executing methods/operations according to various embodiments of the disclosure.

The memory 120 may store one or a combination of two or more of various data, instructions, and information used by components (e.g., the processor 110) included in the electronic device 100. The memory 120 may include volatile memory and/or nonvolatile memory.

The computer program 130 may include one or more actions in which methods/operations according to various embodiments of the disclosure are implemented, and may be stored in the memory 120 in software form. Here, an action may correspond to an instruction realized by the computer program 130. For example, the computer program 130 may include instructions for performing an operation of analyzing user intent by tokenizing a text-format query received from a user into morpheme units, an operation of recommending at least one dish corresponding to the user intent through partial string matching between the query tokenized into morpheme units and a category for each cluster of a pre-constructed unstructured database, and an operation of providing restaurant information related to a dish selected by the user from the at least one recommended dish in conjunction with a map service, based on location information received from the user.

When the computer program 130 is loaded into the memory 120, the processor 110 may perform methods/operations according to various embodiments of the disclosure by executing a plurality of operations for implementing the computer program 130.

The communication link 140 may include a path for transferring at least one of various data, instructions, and information between components included in the electronic device 100. The communication link 140 may be, for example, a peripheral component interconnect (PCI) bus or an extended industry standard architecture (EISA) bus, but the types of such buses are merely examples and are not limited to the above examples. As an example, in FIG. 1, the bus is represented by a single line for convenience of explanation, but in practice, a plurality of buses or various types of buses may be included.

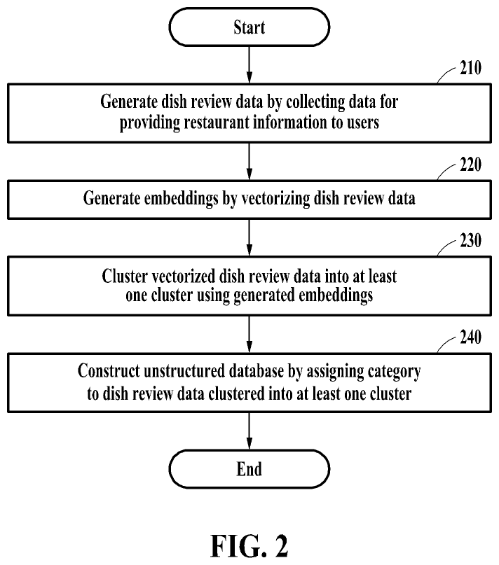

FIG. 2 is a flowchart illustrating a method by which an electronic device constructs an unstructured database, according to an embodiment. In an embodiment, at least one of the operations of FIG. 2 may be performed simultaneously or in parallel with another operation, and the order of the operations may be changed. In addition, at least one of the operations may be omitted, or another operation may be additionally performed. The operations shown in FIG. 2 may be performed by at least one component of an electronic device (e.g., the electronic device 100 of FIG. 1).

In operation 210, a processor of the electronic device (e.g., the processor 110 of FIG. 1) may generate dish review data by collecting data for providing restaurant information to users. According to an embodiment, the processor may collect data about at least one restaurant using web scraping technology. For example, the processor may automatically collect at least one piece of information among restaurant name, address, rating, and review information from specific websites (e.g., Naver Place, etc.) by utilizing browser automation technology such as Selenium. The information collected in this manner may be used as basic data necessary for providing restaurant information to users later.

According to an embodiment, the processor may collect dish names and review information about individual dishes by utilizing already published datasets. For example, the processor may collect various dish names through a “National Integrated Food Nutrition Information.csv” file provided by a public data portal, and may collect dish names for individual dishes and review information related to the dish names through a “Dish Review Data.csv” file provided by Kaggle, a data analysis competition platform.

However, the types and formats of data collected in this manner for providing restaurant information to users are merely examples and are not limited to the above examples.

According to an embodiment, the processor may generate dish review data by matching the dish names and review information about individual dishes collected in this manner. At this time, the processor may generate dish review data by reconstructing each dish name and review information for the corresponding dish name in a [dish name, review] format and storing them in a database. When multiple different reviews exist for the same dish name, the processor may bundle the multiple reviews under the same name and store them as a single data item, as shown in Table 1 below. Through this, the processor may integrate and manage various reviews for the same dish name.

TABLE 1

| Dish | | | |
|---|---|---|---|
| Name | Review | | |
| Chueotang | Chueotang with | Charm of | Chueotang with |
| | rich broth that | Chueotang with | rich broth that |
| | relieves fatigue, | light yet deep | warms you up! |
| | and warms | flavor that | I feel energized |
| | you up! | warms you up! | for another day! |
| Shabu- | In the sweltering | Even in the | Hot shabu-shabu is |
| shabu | heat, I warmed | heat, it keeps | actually more of a |
| | myself with a hot | you warm. | delicacy in the hot |
| | shabu-shabu | Reenergize | summer weather! |
| | bowl! | with a shabu- | |
| | | shabu bowl! | |
| . . . | . . . | . . . | . . . |

In operation 220, the processor may generate embeddings by vectorizing the generated dish review data. More specifically, the processor may convert the dish review data into vector form by analyzing words and sentences in the text of the dish review data to quantify contextual meaning. According to an embodiment, the processor may convert dish review data into a vector form by utilizing a word embedding technique (e.g., Sentence Transformers model and the like). At this time, the Sentence Transformers model utilized may represent each word and sentence in a vector form by considering the meaning and context of words and sentences in the text. For example, a review about “Chueotang”, which is “Chueotang with rich broth that relieves fatigue, and warms you up!”, may be converted into a vector form through the Sentence Transformers model, and may be represented as vector values as shown in Table 2 below.

TABLE 2

| Dish Name | Review |
|---|---|
| Chueotang | 0.78 (warm), 0.64 (fatigue), 0.52 (rich), . . . |
| Shabu-shabu | 0.82 (sweltering heat), 0.71 (fatigue), 0.60 (warm), . . . |

Referring to Table 2, each review may be represented as a vector generated through the Sentence Transformers model, and the contextual meaning of the review may be implemented in an embedding form using such quantified vectors. For example, a review about “Chueotang” may be composed of elements, such as vector values “0.78 (warm)”, “0.64 (fatigue)”, “0.52 (rich)”, and the like. These vector values may be a result of the contextual meaning of the review being quantified and expressed. Such vector values may reflect the contextual importance that each word in the review has in the corresponding review.

In operation 230, the processor may cluster the vectorized dish review data into at least one cluster using the generated embeddings. More specifically, the processor may generate at least one cluster by clustering the vectorized dish review data based on density and distance. According to an embodiment, the processor may perform clustering by analyzing the density and distance of the vectorized dish review data using Equation 1 below.

$${d}_{m r e a c h - k} ( a , b ) = max ( {core}_{k} ( a ) , {core}_{k} ( b ) , d ( a , b ) ) \qquad [ Equation l ]$$

Here, d_{mreach-k}(a, b) represents the mutual reachability distance between vectorized dish review data a and b, coreₖ(a) and coreₖ(b) mean the core distances of vectorized dish review data a and b, and d(a, b) means the actual distance between vectorized dish review data a and b.

Referring to Equation 1, the processor may compare the actual distance between vectorized dish review data and the respective core distances of each vectorized dish review data using the max function. Through this, the processor may evaluate reachability considering both density and distance simultaneously to cluster vectorized dish review data, thereby including reviews with the same characteristics in the same cluster. At this time, the processor may regard vectorized dish review data with low density or poor reachability with surrounding data as noise and remove such data from the clustering process.

For example, the processor may cluster vectorized dish review data into any one of the following clusters: situation cluster, atmosphere cluster, emotion cluster, preference cluster, weather cluster, and time cluster. However, the types and number of such clusters are merely examples and are not limited to the above examples.

In operation 240, the processor may construct an unstructured database by assigning a category to dish review data clustered into at least one cluster. According to an embodiment, the processor may assign a category to the dish review data clustered into at least one cluster, using a first classification model trained to assign one of the predefined categories to each cluster.

For example, the processor may fine-tune an existing trained classification model (e.g., a first classification model) using a specific dataset, and may assign an optimal category to clustered dish review data through the fine-tuned model. More specifically, the processor may convert labeled dish review data into integers. The processor may load an existing trained classification model (e.g., bidirectional encoder representations from transformers (BERT)) and perform additional training using the dish review data converted into corresponding integers, thereby generating a fine-tuned first classification model with improved classification accuracy for specific categories.

The processor may assign a primary category to dish review data clustered into at least one cluster, using the first classification model generated in this manner. For example, when vectorized dish review data is clustered into a situation cluster, the first classification model may classify the corresponding vectorized dish review data into one of a plurality of predefined categories (e.g., fatigue recovery, popular restaurant, hearty, company dinner, and the like) corresponding to the situation cluster.

According to an embodiment, the processor may assign additional categories to dish review data to which a primary category has been assigned, using a second classification model trained to assign a secondary category based on representative reviews for each cluster. For example, the processor may assign a secondary category to dish review data to which a primary category has been assigned, using a zero-shot learning (ZSL) model (e.g., a second classification model) that can recognize and classify objects or concepts without examples of predefined categories or concepts.

More specifically, the processor may assign a newly generated category rather than a predefined category by applying the second classification model to dish review data to which no category has been assigned through the first classification model. For example, when dish review data is clustered into a situation cluster through the first classification model but is not assigned to an existing category, the second classification model may generate and assign a new category suitable for the corresponding dish review data (e.g., memory recollection and the like).

Alternatively, the processor may assign a more subdivided category than a predefined category to the corresponding dish review data by applying the second classification model to dish review data to which a primary category has been assigned through the first classification model. For example, when dish review data is clustered into a situation cluster through the first classification model and assigned a fatigue recovery category, the second classification model may generate and assign a more subdivided category than the fatigue recovery category (e.g., nutrition supplementation or immunity enhancement, or the like) to the corresponding dish review data.

According to an embodiment, the processor may construct an unstructured database using the Java Simulation Library (JSL) model, as shown in Equation 2 below.

$$p ( y \vert x , {X}_{s} , {F}_{s} , W , θ = {\sum }_{v ∈ \{ s , u \}} P ( y \vert V , x , {X}_{s} , {F}_{s} , W , θ ) \qquad [ Equation 2 ]$$

Here, y represents the category predicted as a result of classification, and x represents the review text used as input for the ZSL model. At this time, the representative review of each cluster may be used as input for the ZSL model. Xₛ represents a feature vector of the pre-trained dataset. For example, dish review data vectorized using a word embedding technique may become a set of feature vectors of a dataset that a fine-tuned model has pre-trained, and the set of feature vectors may be substituted as Xₛ. In the disclosure, such dish review data may correspond to feature vectors trained through the fine-tuned model.

F₃ represents a semantic vector corresponding to the feature vector of a pre-trained dataset. In the disclosure, label variables may define semantic categories corresponding to Fₛ, and may be set as labels=[“situation”, “atmosphere”, “emotion”, “preference”, “weather”, “time” ]. The ZSL model can predict to which semantic category each review belongs by referencing the corresponding labels when classifying vectorized dish review data. For example, the ZSL model may receive Xₛ as input, which is a feature vector of the pre-trained dataset, and output the most suitable category among the categories set in labels by matching the most suitable category as Fₛ.

W is a weight matrix that maps feature vectors of the pre-trained dataset to the semantic space. The weights included in the corresponding weight matrix are results learned from the fine-tuned model, which may connect vectorized dish review data with semantic categories defined in labels.

θ represents a set of optimization parameters of the ZSL model. More specifically, θ represents all parameters that the ZSL model has adjusted during the learning process. Including W, θ can be used to optimize the overall performance of the ZSL model and can be used when calculating the probability that input data belongs to a specific category.

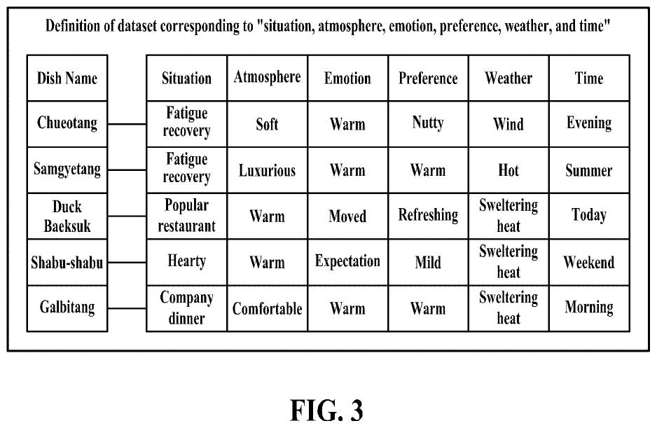

According to an embodiment, FIG. 3 shows an example of constructing an unstructured database for providing interactive chatbot search services based on personal characteristics and experiences by assigning a category to dish review data clustered into at least one cluster. The unstructured database may be assigned at least one cluster (e.g., situation, atmosphere, emotion, preference, weather, and time) corresponding to each dish name and a category (e.g., in the case of a situation cluster, fatigue recovery, popular restaurant, hearty, company dinner, and the like) suitable for each cluster.

The unstructured database constructed in this way can be used to provide customized information based on various conditions (e.g., personal characteristics and experiences) requested by the user.

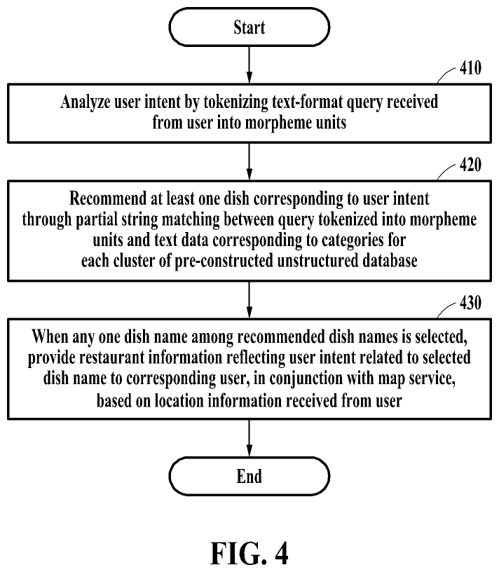

FIG. 4 is a flowchart illustrating a method by which an electronic device provides search services using an unstructured database, according to an embodiment. In an embodiment, at least one of the operations of FIG. 4 may be performed simultaneously or in parallel with another operation, and the order of the operations may be changed. In addition, at least one of the operations may be omitted, or another operation may be additionally performed. The operations shown in FIG. 4 may be performed by at least one component of an electronic device (e.g., the electronic device 100 of FIG. 1).

In operation 410, a processor of the electronic device (e.g., the processor 110 of FIG. 1) may analyze user intent by tokenizing a text-format query received from a user into morpheme units. At this time, the processor may identify user intent by performing morphological analysis using generative artificial intelligence (AI).

More specifically, the processor may extract key keywords by performing morphological analysis on the received query using a library for natural language processing (NLP) and removing unnecessary words for analysis, such as particles and conjunctions.

For example, the processor may extract key keywords by performing morphological analysis on the received query using a Korean NLP library such as Korean natural language processing in Python (KoNLPy). If the query “please recommend popular warm dish restaurants that are good for fatigue recovery in sweltering heat” is received from a user, the processor may extract key keywords such as “sweltering heat”, “fatigue recovery”, “warm dish”, and “popular restaurant recommendation” through morphological analysis.

The processor may analyze user intent for the received query by vectorizing the key keywords extracted in this manner to reflect contextual meaning. For example, the processor may use word embedding to map key keywords to a vector space and place words with contextual similarity adjacent, thereby more accurately identifying user intent for the query.

If key keywords such as “sweltering heat”, “fatigue recovery”, “warm dish”, and “popular restaurant recommendation” are extracted from a user query, the processor may classify “sweltering heat” into a weather-related cluster, “fatigue recovery” into a situation-related cluster, and “warm” into a preference-related cluster through word embedding, thereby analyzing user intent as “popular restaurant recommendation related to warm dishes that can help recover from being fatigued in hot weather”.

In operation 420, the processor may recommend at least one dish corresponding to user intent through partial string matching between the query tokenized into morpheme units and text data corresponding to categories for each cluster of the pre-constructed unstructured database. The pre-constructed unstructured database may include at least one cluster, and each cluster may include text data corresponding to at least one category.

For example, the unstructured database may include a dish name and at least one cluster among a situation cluster, atmosphere cluster, emotion cluster, preference cluster, weather cluster, and time cluster related to the corresponding dish name. Each cluster may be assigned at least one category (e.g., in the case of a situation cluster, fatigue recovery, popular restaurant, hearty, company dinner, and the like).

When the query received from a user is “please recommend popular warm dish restaurants that are good for fatigue recovery in sweltering heat”, the processor may extract key keywords such as “sweltering heat”, “fatigue recovery”, “warm dish”, and “popular restaurant recommendation” through morphological analysis of the received query. The processor may perform partial string matching with text data corresponding to each category of the unstructured database by decomposing each key keyword extracted in this manner into character units.

According to an embodiment, the processor may identify the number of categories in the unstructured database that match the query tokenized into morpheme units through partial string matching, and may determine the type of dish to be recommended to a user based on the identified number of categories. For example, the processor may recommend a preset number (e.g., N) of dish names to a user in order of the highest number of matching categories.

In operation 430, when any one dish name among the recommended dish names is selected, the processor may provide restaurant information reflecting the user intent related to the selected dish name to the corresponding user, in conjunction with a map service, based on location information received from the user. At this time, the processor may generate restaurant information through generative AI, based on the dish name selected by the user and location information, and provide a more natural user experience by providing the generated restaurant information in a conversational format of a chatbot.

For example, when shabu-shabu is selected among dish names recommended by a user and location information of Jongno-gu, Seoul is received, the processor may extract and provide to the user shabu-shabu restaurants reflecting user intent, such as “popular restaurant recommendation related to warm dishes that can help recover from being fatigued in hot weather” among shabu-shabu restaurants in Jongno-gu, Seoul.

According to an embodiment, the processor may display the location of the corresponding restaurant on a map by linking the extracted restaurant information with map services (e.g., map services (e.g., map application programming interfaces (APIs) such as CesiumJS, Google Maps, Naver Maps, and Kakao Maps)), thereby not only allowing users to recognize the location of the corresponding restaurant intuitively, but also providing real-time route guidance functions to improve accessibility to restaurants they wish to visit.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

Although the example embodiments have been described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

This application corresponds to results obtained with support from the Ministry of Land, Infrastructure and Transport under the National Spatial Information Human Resource Development (2025 Spatial Information Specialized College Development Project).

What is claimed is:

1. An electronic device, comprising:
at least one processor including processing circuitry; and
a memory including one or more storage media storing instructions,
wherein the instructions, when executed by the at least one processor individually or collectively, cause the electronic device to:
analyze user intent by tokenizing a text-format query received from a user into morpheme units,
recommend at least one dish corresponding to the user intent through partial string matching between the text-format query tokenized into morpheme units and a category for each cluster of a pre-constructed unstructured database, and
provide restaurant information related to a dish selected by the user from the at least one recommended dish in conjunction with a map service, based on location information received from the user.

2. The electronic device of claim 1, wherein the instructions, when executed by the at least one processor individually or collectively, cause the electronic device to:
determine a type of dish to be recommended to the user, based on a number of categories of the unstructured database that match the tokenized query through the partial string matching.

3. The electronic device of claim 1, wherein the instructions, when executed by the at least one processor individually or collectively, cause the electronic device to:
vectorize dish review data including a dish name and at least one piece of review information corresponding to the dish name,
cluster the vectorized dish review data into at least one cluster, and
pre-construct the unstructured database by assigning a category to the dish review data included in the at least one cluster based on a predetermined classification method.

4. The electronic device of claim 3, wherein the instructions, when executed by the at least one processor individually or collectively, cause the electronic device to:
generate at least one cluster by clustering the vectorized dish review data based on density and distance.

5. The electronic device of claim 3, wherein the instructions, when executed by the at least one processor individually or collectively, cause the electronic device to:
assign a category to the dish review data included in the at least one cluster through a first classification model trained to assign one of predefined categories for each of the at least one cluster to the dish review data included in the at least one cluster, and a second classification model trained to assign a new category using a representative review for each of the at least one cluster.

6. A method of operating an electronic device, the method comprising:
analyzing user intent by tokenizing a text-format query received from a user into morpheme units;
recommending at least one dish corresponding to the user intent through partial string matching between the text-format query tokenized into morpheme units and a category for each cluster of a pre-constructed unstructured database; and
providing restaurant information related to a dish selected by the user from the at least one recommended dish in conjunction with a map service, based on location information received from the user.

7. The method of claim 6, wherein the recommending of the at least one dish corresponding to the user intent comprises:
determining a type of dish to be recommended to the user, based on a number of categories of the unstructured database that match the tokenized query through the partial string matching.

8. The method of claim 6, wherein the unstructured database is generated by:
vectorizing dish review data including a dish name and at least one piece of review information corresponding to the dish name,
clustering the vectorized dish review data into at least one cluster, and
assigning a category to the dish review data included in the at least one cluster based on a predetermined classification method.
